(19) United States
(12) Patent Application Publication
(10) Pub. No.: US 2025/0225572 A1
(43) Pub. Date: Jul. 10, 2025

(54) ARTIFICIAL INTELLIGENCE VIRTUAL ASSISTANT USING STAGED LARGE LANGUAGE MODELS

(71) Applicant: Loop Now Technologies, Inc., San Mateo, CA (US)

(72) Inventors: Edwin Chiu, Cupertino, CA (US); Shi Feng, East Palo Alto, CA (US); Wu-Hsi Li, Somerville, MA (US); Jerry Ting Kwan Luk, Menlo Park, CA (US)

(73) Assignee: Loop Now Technologies, Inc., San Mateo, CA (US)

(21) Appl. No.: 19/093,376

(22) Filed: Mar. 28, 2025

Related U.S. Application Data
(63) Continuation-in-part of application No. 18/989,061, filed on Dec. 20, 2024.
Application No. 18/989,061 is a continuation-in-part of application No. 18/820,456, filed on Aug. 30, 2024.
Application No. 18/820,456 is a continuation-in-part of application No. 18/585,212, filed on Feb. 23, 2024.
(60) Provisional application No. 63/649,966, filed on May 21, 2024.
(60) Provisional application No. 63/638,476, filed on Apr. 25, 2024.
(60) Provisional application No. 63/571,732, filed on Mar. 29, 2024.
(60) Provisional application No. 63/557,622, filed on Feb. 26, 2024.
(60) Provisional application No. 63/557,623, filed on Feb. 26, 2024.
(60) Provisional application No. 63/557,628, filed on Feb. 26, 2024.
(60) Provisional application No. 63/613,312, filed on Dec. 21, 2023.
(60) Provisional application No. 63/604,261, filed on Nov. 30, 2023.
(60) Provisional application No. 63/546,768, filed on Nov. 1, 2023.
(60) Provisional application No. 63/546,077, filed on Oct. 27, 2023.
(60) Provisional application No. 63/536,245, filed on Sep. 1, 2023.
(60) Provisional application No. 63/524,900, filed on Jul. 4, 2023.
(60) Provisional application No. 63/522,205, filed on Jun. 21, 2023.
(60) Provisional application No. 63/472,552, filed on Jun. 12, 2023.
(60) Provisional application No. 63/464,207, filed on May 5, 2023.
(60) Provisional application No. 63/458,733, filed on Apr. 12, 2023.
(60) Provisional application No. 63/458,458, filed on Apr. 11, 2023.
(60) Provisional application No. 63/458,178, filed on Apr. 10, 2023.
(60) Provisional application No. 63/454,976, filed on Mar. 28, 2023.
(60) Provisional application No. 63/447,918, filed on Feb. 24, 2023.
(60) Provisional application No. 63/447,925, filed on Feb. 24, 2023.

(51) Int. Cl. G06Q 30/0601; G06Q 30/015

(52) U.S. Cl. CPC G06Q 30/0643; G06Q 30/015

(57) ABSTRACT

Techniques for video processing using artificial intelligence are disclosed. An embedded interface included on a website and/or mobile application is accessed. The embedded interface includes one or more products for sale. A user requests an interaction based on a product for sale. A first video segment including a synthetic human is displayed to the user. The embedded interface collects user input in response to the video segment. One or more classifiers, which can comprise one or more lightweight LLMs, classify the user input, identifying a type of conversation. The user input is routed by a controller to a module which provides instructions to a final LLM. The final LLM creates a response to the interaction with the user, based on the instructions. The response is used to generate a second video segment that is displayed to the user.

### RELATED APPLICATIONS

This application claims the benefit of U.S. provisional patent applications “Artificial Intelligence Virtual Assistant Using Staged Large Language Models” Ser. No. 63/571,732, filed Mar. 29, 2024, “Artificial Intelligence Virtual Assistant In A Physical Store” Ser. No. 63/638,476, filed Apr. 25, 2024, and “Ecommerce Product Management Using Instant Messaging” Ser. No. 63/649,966, filed May 21, 2024.

This application is also a continuation-in-part of U.S. patent application “Artificial Intelligence Virtual Assistant Using Large Language Model Processing” Ser. No. 18/989,061, filed Dec. 20, 2024, which claims the benefit of U.S. provisional patent applications “Artificial Intelligence Virtual Assistant Using Large Language Model Processing” Ser. No. 63/613,312, filed Dec. 21, 2023, “Artificial Intelligence Virtual Assistant With LLM Streaming” Ser. No. 63/557,622, filed Feb. 26, 2024, “Self-Improving Interactions With An Artificial Intelligence Virtual Assistant” Ser. No. 63/557,623, filed Feb. 26, 2024, “Streaming A Segmented Artificial Intelligence Virtual Assistant With Probabilistic Buffering” Ser. No. 63/557,628, filed Feb. 26, 2024, “Artificial Intelligence Virtual Assistant Using Staged Large Language Models” Ser. No. 63/571,732, filed Mar. 29, 2024, “Artificial Intelligence Virtual Assistant In A Physical Store” Ser. No. 63/638,476, filed Apr. 25, 2024, and “Ecommerce Product Management Using Instant Messaging” Ser. No. 63/649,966, filed May 21, 2024.

The U.S. patent application “Artificial Intelligence Virtual Assistant Using Large Language Model Processing” Ser. No. 18/989,061, filed Dec. 20, 2024 is also a continuation-in-part of U.S. patent application “Livestream With Large Language Model Assist” Ser. No. 18/820,456, filed Aug. 30, 2024, which claims the benefit of U.S. provisional patent applications “Livestream With Large Language Model Assist” Ser. No. 63/536,245, filed Sep. 1, 2023, “Non-Invasive Collaborative Browsing” Ser. No. 63/546,077, filed Oct. 27, 2023, “AI-Driven Suggestions For Interactions With A User” Ser. No. 63/546,768, filed Nov. 1, 2023, “Customized Video Playlist With Machine Learning” Ser. No. 63/604,261, filed Nov. 30, 2023, “Artificial Intelligence Virtual Assistant Using Large Language Model Processing” Ser. No. 63/613,312, filed Dec. 21, 2023, “Artificial Intelligence Virtual Assistant With LLM Streaming” Ser. No. 63/557,622, filed Feb. 26, 2024, “Self-Improving Interactions With An Artificial Intelligence Virtual Assistant” Ser. No. 63/557,623, filed Feb. 26, 2024, “Streaming A Segmented Artificial Intelligence Virtual Assistant With Probabilistic Buffering” Ser. No. 63/557,628, filed Feb. 26, 2024, “Artificial Intelligence Virtual Assistant Using Staged Large Language Models” Ser. No. 63/571,732, filed Mar. 29, 2024, “Artificial Intelligence Virtual Assistant In A Physical Store” Ser. No. 63/638,476, filed Apr. 25, 2024, and “Ecommerce Product Management Using Instant Messaging” Ser. No. 63/649,966, filed May 21, 2024.

The U.S. patent application “Livestream With Large Language Model Assist” Ser. No. 18/820,456, filed Aug. 30, 2024 is also a continuation-in-part of U.S. patent application “Synthesized Realistic Metahuman Short-Form Video” Ser. No. 18/585,212, filed Feb. 23, 2024, which claims the benefit of U.S. provisional patent applications “Synthesized Realistic Metahuman Short-Form Video” Ser. No. 63/447,925, filed Feb. 24, 2023, “Dynamic Synthetic Video Chat Agent Replacement” Ser. No. 63/447,918, filed Feb. 24, 2023, “Synthesized Responses To Predictive Livestream Questions” Ser. No. 63/454,976, filed Mar. 28, 2023, “Scaling Ecommerce With Short-Form Video” Ser. No. 63/458,178, filed Apr. 10, 2023, “Iterative AI Prompt Optimization For Video Generation” Ser. No. 63/458,458, filed Apr. 11, 2023, “Dynamic Short-Form Video Transversal With Machine Learning In An Ecommerce Environment” Ser. No. 63/458,733, filed Apr. 12, 2023, “Immediate Livestreams In A Short-Form Video Ecommerce Environment” Ser. No. 63/464,207, filed May 5, 2023, “Video Chat Initiation Based On Machine Learning” Ser. No. 63/472,552, filed Jun. 12, 2023, “Expandable Video Loop With Replacement Audio” Ser. No. 63/522,205, filed Jun. 21, 2023, “Text-Driven Video Editing With Machine Learning” Ser. No. 63/524,900, filed Jul. 4, 2023, “Livestream With Large Language Model Assist” Ser. No. 63/536,245, filed Sep. 1, 2023, “Non-Invasive Collaborative Browsing” Ser. No. 63/546,077, filed Oct. 27, 2023, “AI-Driven Suggestions For Interactions With A User” Ser. No. 63/546,768, filed Nov. 1, 2023, “Customized Video Playlist With Machine Learning” Ser. No. 63/604,261, filed Nov. 30, 2023, and “Artificial Intelligence Virtual Assistant Using Large Language Model Processing” Ser. No. 63/613,312, filed Dec. 21, 2023.

Each of the foregoing applications is hereby incorporated by reference in its entirety.

### FIELD OF ART

This application relates generally to video processing and more particularly to an artificial intelligence virtual assistant using staged large language models.

### BACKGROUND

Communication can be difficult. Several obstacles can hamper effective communication with others. The barriers can occur at several different points in the communication process. For example, physical barriers can clutter, distort, or attenuate the messages we are trying to send or receive. Distance, noise, and technology problems can inhibit the strength and clarity, in either or both directions, of messaging. Language itself can also create barriers. Translation methods are often imperfect, leading to distorted or even unintelligible messages. Accents, slang, regional differences, and so on can obstruct communication even when all parties are using the same base language. Finding common frames of reference and vocabulary can take additional time and resources that distract or significantly slow down the process of communication.

Emotional barriers can also inhibit our ability to communicate. Emotions can take needed energy away from the work of speaking and listening. Emotions can also alter the way in which we hear others or the way we speak to them. Anger or pain can lessen our ability to listen to others patiently, elation or joy can obscure our ability to hear warnings or danger messages clearly, and so on. Cultural barriers can also play a role in making communication more difficult. Gestures, eye contact, and personal space preferences vary from one culture to another. What may be expected in one culture can be offensive or threatening in another. Understanding the culture in which a person is communicating can be essential to sending and receiving messages clearly.

Psychological barriers can also play a part in inhibiting or enhancing communication. Everyone has biases toward different groups of people based on all sorts of criteria. Many of these biases can be hidden, even to the people who hold them. Past experiences can influence the way in which people receive information and emotional content from others. People with traumatic or violent experiences in their past can have heightened awareness toward forceful or aggressive messages, or may have a devil-may-care attitude toward such messages. Either response can distort or exaggerate the messages being sent or received.

Communication barriers can exist within groups as well as individuals. Organizational structures, policies, and procedures can result in hindered communication. Hierarchies can inhibit communication from one level to another. Bureaucracy can slow down messaging from one group to another, either intentionally or unintentionally. Legal barriers can slow or even block communication entirely between one group and another. Semantic barriers can also be involved in poor communication. Misinterpretation of words or symbols, ambiguity or vagueness based on shared experiences, jargon, and acronyms can all lead to misunderstandings within a particular group, and from one group to another. Our perceptions of one another, at an individual or group level, can also play a part in effective or ineffective communication. People tend to focus on specific aspects of others while ignoring other aspects. Skin color, accents, clothing, attractiveness, and health can all trigger stereotypes that affect our understanding of one another. The ability to recognize and minimize these barriers is essential for effective communication. As these barriers are overcome, stronger connections with one another can be built.

### SUMMARY

Effective sales and help desk staff conversations require strong product knowledge, attuned support systems, competitive and flexible pricing, and excellent communication skills. Regardless of whether the interaction is in person or digital, a representative from an organization must know the product or service being discussed, know how to support it, and be able to communicate effectively with the customer. The relationship between the sales or support person and the customer must form quickly and engage the user in a positive manner. Understanding the content and the underlying tone of the conversation is vital to both maintaining the relationship, however temporary, and increasing the likelihood of a return customer. Listening to the customer so as to understand the information they need, addressing a customer's concerns, and presenting the answers in an effective manner takes practice, even for professional sales and customer service staff members. The more quickly and reliably the correct information can be accessed and delivered in a manner that communicates understanding and respect to the customer, the better. As the global market continues to expand sales and support demand, strong sales and support outlets and delivery mechanisms must grow to meet the need.

Techniques for video processing using artificial intelligence are disclosed. An embedded interface included on a website and/or mobile application is accessed. The embedded interface includes one or more products for sale. A user requests an interaction based on a product for sale. A first video segment including a synthetic human is displayed to the user. The embedded interface collects user input in response to the video segment. One or more classifiers, which can comprise one or more lightweight LLMs, classify the user input, identifying a type of conversation. The user input is routed by a controller to a module which provides instructions to a final LLM. The final LLM creates a response to the interaction with the user, based on the instructions. The response is used to generate a second video segment that is displayed to the user.

A computer-implemented method for video processing is disclosed comprising: accessing an embedded interface, wherein the embedded interface includes one or more products for sale; requesting, by a user, an interaction, wherein the interaction is based on a product for sale within the one or more products for sale; displaying, within the embedded interface, a first video segment, wherein the first video segment includes a synthetic human, wherein the first video segment initiates the interaction; collecting, by the embedded interface, user input, wherein the collecting includes one or more user signals; classifying, by one or more classifiers, the user input, wherein the one or more classifiers operate in parallel, wherein the classifying identifies a type of conversation, and wherein the classifying is based on the collecting; routing the user input, by a controller, to one or more modules, wherein the routing is based on the classifying, and wherein the one or more modules provide instructions to a final large language model (LLM); and creating, by the final LLM, a response to the interaction with the user, wherein the response is based on the instructions.

Various features, aspects, and advantages of various embodiments will become more apparent from the following further description.

### BRIEF DESCRIPTION OF THE DRAWINGS

The following detailed description of certain embodiments may be understood by reference to the following figures wherein:

FIG. 1 is a flow diagram for an artificial intelligence virtual assistant using staged large language models.

FIG. 2 is a flow diagram for providing instructions.

FIG. 3 is an infographic for an artificial intelligence virtual assistant using staged large language models.

FIG. 4 is an infographic for routing to one or more modules.

FIG. 5 is an example of an interaction with an artificial intelligence virtual assistant.

FIG. 6 is an example of an artificial intelligence virtual assistant showing a short-form video.

FIG. 7 is an example of an ecommerce purchase.

FIG. 8 is a system diagram for an artificial intelligence virtual assistant using staged large language models.

### DETAILED DESCRIPTION

Online websites and applications that highlight products and services for sale are immensely popular and can engage thousands or even millions of users. The challenge of responding to viewer questions and comments quickly and accurately can be difficult. Accessing the right information quickly and sending it back to the user who is looking for it can be the difference between a sale or a potential customer leaving the website. Understanding the subtleties of conversations with users can be a challenge as well. Users can sometimes begin conversing about one thing and end up talking about something else. The conversation can sometimes start off calmly and later become combative or confrontational. Understanding and responding to such changes effectively and efficiently can be enormously challenging, even for professional sales and support staff people. Large language models (LLMs) including natural language processing (NLP) can help by monitoring the user interactions and generating answers to questions as they arise in a conversation. As the volume of digital communication increases for sales and customer support, the uses of LLMs can help encourage rapid and accurate viewer engagement, increased sales, and long-term customer/vendor relationships.

Techniques for video processing are disclosed. Users interact with an embedded interface. The embedded interface can be a website, mobile application, and so on. The embedded interface includes products for sale by a website or mobile application. A user requests an interaction with a sales or support person, based on one or more products for sale. The embedded interface includes an artificial intelligence (AI) virtual assistant. The AI virtual assistant is represented as a synthetic human host which is selected to engage the user and deliver the information needed to complete a sales or service transaction. The embedded interface displays a first video segment, including the AI virtual assistant initiating the interaction with the user. The embedded interface collects audio, video, and other signals about the user which are then input into one or more classifiers. The one or more classifiers classify the user input and identify a type of conversation based on the user signals collected. The one or more classifiers can comprise one or more lightweight large language models (LLMs), one or more semantic searches, or any combination of these. Other types of classifiers can be included. The conversation classification is used to route the user input to one or more modules that provide instructions to an LLM. The modules include programmable templates that include a markup language. The modules can incorporate the user signals to generate customized instructions to feed into the final LLM. The final LLM generates one or more detailed text responses to the user input, including instructions for producing a second video segment featuring the synthetic human performing the text responses. The final LLM instructions can include details regarding verbal tone, gestures, body language, and other aspects of the synthetic human performance that can address the emotional state of the user as well as deliver the information to the user desires. The video segment is presented to the user and the conversation between the user and the synthetic human continues. The one or more classifiers can run in parallel, each determining if a certain type of conversation is taking place. Thus, the classification of the conversation can be ongoing. The classification can occur every 200 milliseconds or on another schedule. This allows the final LLM responses to continually adjust to both the tone of the user and the evolving requirements for sales and support information.

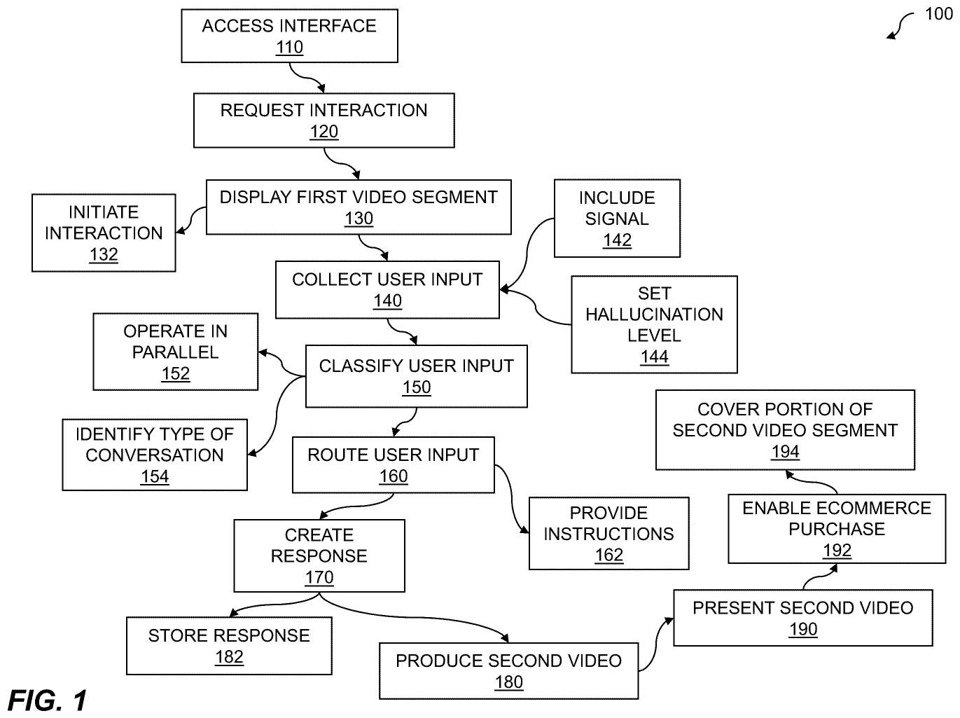

FIG. 1 is a flow diagram for an artificial intelligence virtual assistant using staged large language models. The flow 100 includes accessing 110 an embedded interface, wherein the embedded interface includes one or more products for sale. In embodiments, the embedded interface can comprise a website. The website can be an ecommerce site for a single vendor or brand, a group of businesses, a social media platform, and so on. In embodiments, the website can be displayed on a portable device. The portable device can be an Over-the-Top (OTT) device such as a mobile phone, laptop computer, tablet, or pad. The accessing of the website can be accomplished using a browser running on the device. In embodiments, the embedded interface comprises an app running on a mobile device. The app can use HTTP, TCP/IP, or DNS to communicate with the Internet, web servers, cloud-based platforms, and so on.

The flow 100 includes requesting 120, by a user, an interaction, wherein the interaction is based on a product for sale within the one or more products for sale. In embodiments, the user can request an interaction by clicking on an icon or button displayed in the embedded interface or on a help button on a web page, asking for help in a text chat box, navigating to a help desk screen, pressing a phone button during a call, submitting an email to a help desk address, and so on. The requesting can include responding, by the user, to a call to action (CTA). The CTA can be machine-learning generated. The CTA can be sent to the user via a text message, presented on a website, and so on. The CTA can be included with a question that can be answered by the digital human after the user clicks on the CTA. The CTA can be curated by the machine learning algorithm. The machine learning algorithm can be trained so that the CTA is relevant to the user. The user can initiate an interaction from the main web page of a website, a help menu page, a web page presenting a specific product, a text or video chatbot embedded in the website, and so on. In embodiments, the user can request an interaction by speaking into a microphone connected to the embedded interface. The microphone can be included on a computer, mobile device, and so on. The flow 100 includes displaying 130, within the embedded interface, a first video segment, wherein the first video segment includes a synthetic human, wherein the first video segment initiates 132 the interaction. In embodiments, the first video segment can display a synthetic human initiating a response to the user interaction request. For example, the synthetic host can say “How may I help you?” or “Good day! What can I do for you?” In cases where the user has asked for help from a specific product web page, the initial synthetic human interaction can be more specific. In this instance, the synthetic host can say, “Hello. I see that you are looking at our universal cooking pot. What questions can I answer for you?” The synthetic human can be based on an image of a live human. The synthetic human can be based on images captured from media sources including one or more photographs, videos, livestream events, and livestream replays. The voice of a human can be recorded and included in the synthetic human. The synthetic human can include a synthesized voice.

The flow 100 includes collecting 140, by the embedded interface, user input, wherein the collecting includes 142 one or more user signals. In embodiments, the user input can comprise text. The user can respond to the synthetic human by typing a question or comment into a chat text box. The text box can be generated by the website or the embedded interface window. The user input can comprise audio input. The audio input can include speaking into a video chat window; into a mobile phone, pad, or tablet; and so on. The audio input can be analyzed to collect one or more user signals. The collecting can further comprise transforming the audio input into text, wherein the transforming is accomplished with a speech-to-text converter. The user input can comprise video input. The video input can be collected by a webcam, phone, tablet, or another video device. The video input can be analyzed to collect one or more user signals. The video input can include audio input which can be analyzed, recorded, and/or transformed by a speech-to-text converter. The user input can comprise a video of the user.

In embodiments, the one or more user signals 142 can include information from the website or mobile device hosting the embedded interface. The one or more user signals can include various information about the user which can be helpful in creating a response to the user input. In embodiments, the one or more user signals include a tone of the user. The tone of the user can be detected from a voice or video of the user that was captured. The tone can comprise a sentiment. For example, wild hand movements and/or an elevated voice can be an indication of an angry tone or sentiment. This can guide the LLM in generating a response that is helpful to calm the user. In other embodiments, the one or more user signals include demographic data of the user. Demographic information can help an LLM to generate relevant responses. For example, knowing the gender of a user can direct the LLM to create a response that can be more relevant. In other embodiments, the one or more user signals include purchase history of the user. Knowing what a user has purchased in the past can help an LLM to generate other relevant product recommendations for the user. In further embodiments, the one or more user signals include a video or picture of the user. A video or picture of the user can indicate a mood, tone, sentiment, and so on of the user. This information can also provide other information such as clothing, jewelry, makeup and so on that the user is wearing. These signals can also be helpful in generating a response to the user's input. LLM models have been known to hallucinate. When an LLM mode hallucinates, it can generate irrelevant answers to questions asked or data provided. Thus, in embodiments, the one or more user signals include the probability of introducing, by one or more classifiers, a hallucination.

The probability of hallucination can depend on the answerability of the user input. For example, user input can include a question for which there is a straightforward right or wrong answer. In this case, the probability of a hallucination can be low. This can be due to a low setting of a tolerance level 144. However, the user input can include a multi-category question, or it can be seeking general advice. In these situations, the probability of hallucinating can be higher. In addition, the probability of hallucination can be higher when information regarding the one or more products is lacking. Embodiments can include setting a hallucination tolerance level 144. This can limit the impact of a hallucination. The tolerance level can prevent an incorrect answer by the final LLM. For example, if the user input comprises a question about medical advice, the hallucination tolerance level 144 can be set extremely low. The low setting may prevent the LLM from answering the question and instead can trigger an action such as alerting a human.

The one or more user signals can comprise a user location, website, and social media search information gathered from search engines, gestures, verbal tone of the user, and so on. In some embodiments, a Mel spectrogram audio analysis of the user responses can be used to distinguish spoken words, recognize specific voices, or separate environmental noise from voices. In some embodiments, the audio analysis can be used to distinguish emotional content in the voice of the speaker. The Mel spectrogram audio analysis can be used to distinguish individual words and phonemes that make up words in the user input.

The flow 100 includes classifying 150, by the one or more classifiers, the user input, wherein the one or more classifiers operate in parallel 152, wherein the classifying identifies a type of conversation 154, and wherein the classifying is based on the collecting. In embodiments, the one or more classifiers comprise one or more lightweight LLMs. A large language model (LLM) is a type of machine learning model that can perform a variety of natural language tasks, including generating and classifying text, answering questions in a human conversational manner, and translating text from one language to another. In embodiments, the LLM can be trained with voice and text interactions between users, human sales associates, help desk staff members, product experts, and AI virtual assistants. The one or more lightweight LLMs can comprise one or more “instant LLMs” or one or more “low-parameter LLMs.” A lightweight LLM can create a response in 300 ms or less. A lightweight LLM is a language model that is designed to be compact, efficient, and low-latency while maintaining reasonable performance. Lightweight LLMs are useful for scenarios where real-time responsiveness is crucial. In embodiments, the one or more classifiers can comprise one or more semantic searches. A semantic search can understand a user's intent and take that into account in a search algorithm. A semantic search can provide data faster than a lightweight LLM and thus can be useful to classify 150 user input and identify a type of conversation 154 the user wishes to have with the synthetic human. In embodiments, the one or more classifiers can include any combination of lightweight LLMs and semantic searches. The one or more classifiers, which can be a combination of lightweight LLMs and/or semantic searches, can run in parallel 152 on the user input. Running multiple processes in parallel 152 ensures that the classification of the user input can occur quickly.

Once the user's intention is known, additional classifying can be performed. The additional classifying can include a knowledge tree. The knowledge tree can be based on the one or more products for sale and can include information that the heavy LLM can use to generate a relevant response to the user. The knowledge tree can include information needed for any number of products, and various paths through the tree can represent information needed for different products. For example, a user can ask for a shoe recommendation while the classifying can indicate an intention of the user to purchase a product. The heavy LLM can then use a “shoe path” in the knowledge tree to determine what additional information is needed to make a shoe recommendation to the user. This information can include size, style preferences, men's or women's fashion, type of shoe, and so on. If this information is not already available via the interaction, the heavy LLM can create a query to the user requesting the missing information. The LLM can interact with the user in this way until it obtains the information, as defined by the knowledge tree, necessary to make the product recommendation. The query can be based on missing information from the knowledge tree. Once the missing information is gathered, the heavy LLM can create a final recommendation that was requested by the user. In embodiments, the classifying includes a knowledge tree, wherein the knowledge tree identifies information needed, by the final LLM, for the creating.

Users can initiate an interaction with a human or synthetic host for many different reasons. The user may be searching for information about a product or service in preparation to make a purchase. The user may be asking about the status of a product already purchased but not delivered. The user may be attempting to return an item or purchase more of the same. A product may have been damaged in shipment, may be the wrong color or the wrong size, and so on. The user may want to complain about limited selections, changes in pricing, availability, or delivery times. The user may be looking for advice. The user may just want to vent or may be in a playful mood and the interaction may not relate to the one or more products for sale. Depending on the type of website, the services, and the products being offered, user interactions can take many different forms with one or more agendas. In addition, the attitude of the user can vary. Users can be calm or agitated, happy or angry, highly emotional and demonstrative, or at ease.

User input can be forwarded to the one or more classifiers to determine the type of conversation 154 the user wishes to have with the synthetic human. In embodiments, the type of conversation includes a greeting. In other embodiments, the type of conversation includes an inquiry. In further embodiments, the type of conversation includes a chat, wherein the chat is not based on the one or more products for sale. In still other embodiments, the type of conversation includes a sentiment. In embodiments, the type of conversation includes a request for information. Many other types of conversations are possible. In practice, each classifier can search a type of conversation in parallel 152 so that all types of conversations can be identified concurrently, increasing the speed and accuracy of generating a response to the user.

The flow 100 includes routing 160 the user input, by a controller, to one or more modules, wherein the routing is based on the classifying, and wherein the one or more modules provide instructions 162 to a final large language model (LLM). In embodiments, one or more modules can be used to arrange and prioritize user input based on the analysis of the one or more classifiers. The router can route the user input that was collected to the appropriate module. In embodiments, the one or more modules include an exploration module. An exploration module can be used when the user's intent is determined to be exploring products, services, uses of products, and so on. In other embodiments, the one or more modules include a clarification module. A clarification module can be used when a user's question can be answered by clarifying one or more details about a product, a use of the product, a term of purchase, and so on. In further embodiments, the one or more modules includes a closing module. A closing module can be used when the user is close to making a purchase decision. In other embodiments, the one or more modules includes a finding help module. A finding help module can be used when a user cannot be helped by the synthetic human. In this case, the virtual assistant can alert a human that additional help is required for the user. In embodiments the one or more modules include a troubleshooting module. This module can be used when something goes wrong with the virtual assistant, a classifier suffers a hallucination, a hallucination level is exceeded, not enough product information is available to interact with the user, and so on. In embodiments, the one or more modules can include an advisory module. The advisory module can be used when the user is interested in obtaining advice. For example, the user may be interested in obtaining a wine pairing for a specific meal. The advisory module can be used to determine one or more pairings to suggest to the user for consideration and purchase. The advisory module can instruct the final LLM to take a more proactive tone with the user.

Each module can provide instructions 162 to a final LLM. The instructions can include all that is known about the user. This can include the information from the one or more classifiers as well as the signals that were collected. Thus, the instructions can include the user's intention, tone, mood, background, previous purchase history, type of conversation, and so on. The instructions can be used by the LLM to create a response to the user. The instructions can ensure that responses generated by the final LLM serve to provide the user the information they are requesting and address the emotional content of the conversation.

The flow 100 includes creating 170, by the final LLM, a response to the interaction with the user, wherein the response is based on the instructions. In embodiments, the final LLM comprises a heavy LLM. A heavy LLM can be a “high parameter space LLM.” A heavy LLM can create a response in one second or more. A heavy LLM is a large language model that is resource-intensive in terms of computational requirements and memory usage. Heavy LLMs are designed to handle complex language tasks, to generate high-quality text, and to achieve state-of-the-art performance. They are trained on massive datasets. Heavy LLMs are large in terms of model size. They are especially good at natural language processing (NLP) tasks such as language translation, summarization, and content generation. They also have the advantage of being able to adapt to specific applications based on domain-specific data.

In embodiments, the final LLM can be trained on product and service data related to items sold by website or mobile application hosting the embedded interface. The product and service data can reside in a knowledge database that is accessible and updatable by a seller of the product or service. Additional training data can be provided by product vendor sites, product expert videos, marketing and advertising materials, sales staff input, and so on. Previous user interactions can also be included in the final LLM training data, so that the final LLM responses become increasingly tailored to the needs of the users. In embodiments, the conversation module selected by the router can include all user input signals including the kind of information being sought and the general attitude of the user. The user information can be analyzed by the final LLM to generate a response to the user that addresses both the emotional tone and the information-based aspects of the conversation between the user and synthetic human host. In embodiments, the final LLM response can be a text file that includes instructions for the video production step, as well as the words to be spoken by the synthetic human.

The flow 100 includes producing 180 a second video segment, wherein the second video segment includes a performance by the synthetic human, wherein the performance includes the response that was created. In embodiments, the text of the response to the user generated by the final LLM is used to create a set of video clips including the synthesized human performing the response. The text response to the user can be used to create an audio stream using the voice of the synthesized human used in the first response to the user. The audio stream can be broken down into smaller segments based on natural language processing (NLP) analysis. Each audio segment can be used to produce a video clip of the synthesized human performing the audio segment. Based on the content of the audio, the synthesized human can hold up and demonstrate a product, show the product at different angles, describe various ways of using the product, place the product on the synthetic head or body, and so on. The audio segments can be sent to multiple processors to increase the rate at which video clips are produced and assembled into a second video segment.

The flow 100 includes presenting 190, within the embedded interface, the second video segment that was produced. The embedded interface can display the assembled video segment performed by the synthetic human in a web page window, video chat window, etc. In embodiments, the user can continue to interact with the synthetic human, generating additional input collected by the embedded interface. The collection of user input, creating a response, producing audio segments and related video clips, and presentation to the user continues, so that the interaction between the user and the synthetic human appears as natural as two humans interacting within a video chat. In other embodiments, the voice of the synthetic human is heard in a phone call or text chat box. The conversation between the user and the synthetic human can continue in the same way, with the LLM analyzing input from the user and responding with text replies performed by the voice of the synthetic human. Embodiments include storing 182, in a library, the response to the interaction. Storing the response can ensure that the response can be used by the final LLM for additional learning and accuracy. The library can comprise various media types, including video, text, audio, pictures, and so on. The library can be online. Further, storing the response can allow a faster response to a similar question with similar user signals in the future. The response can be used for a different user. In this case, a semantic search classifier can search a library of previous responses to be sent, by the router, to an appropriate module.

In embodiments, the presenting includes enabling 192 an ecommerce purchase of the product for sale. In embodiments, the enabling can include a representation of the product for sale in an on-screen product card. In other embodiments, the enabling the ecommerce purchase includes a virtual purchase cart. The ecommerce purchase can include showing, within a short-form video or livestream, the virtual purchase cart. In embodiments, the virtual purchase cart covers 194 a portion of the second video segment. A livestream host can demonstrate, endorse, recommend, and otherwise interact with the product for sale. An ecommerce purchase of at least one product for sale can be enabled to the viewer, wherein the ecommerce purchase is accomplished within the video window. As the host, which can be an artificial intelligence virtual assistant, interacts with and presents the product for sale, a product card representing one or more products for sale can be included within a video shopping window. An ecommerce environment associated with the second video segment can be generated on the viewer's mobile device or other connected television device as the rendering of the video progresses. The ecommerce environment on the viewer's mobile device can display a livestream or other video event and the ecommerce environment at the same time. A mobile device user can interact with the product card in order to learn more about the product with which the product card is associated. While the user is interacting with the product card, the second video segment can continue to play. Purchase details of the product for sale can be revealed, wherein the revealing is rendered to the viewer. The viewer can purchase the product through the ecommerce environment, including a virtual purchase cart. The viewer can purchase the product without having to “leave” the second video segment. Leaving the second video segment can include having to disconnect from the event, open an ecommerce window separate from the livestream event, and so on. The second video segment can continue to play while the viewer is engaged with the ecommerce purchase. Additional video segments, comprising additional interactions, can play while the product card remains revealed. In embodiments, the video segment can continue “behind” the ecommerce purchase window, where the virtual purchase window can obscure or partially obscure the livestream event. In some embodiments, the synthesized video segment can display the virtual product cart while the synthesized video segment plays. The virtual product cart can cover a portion of the synthesized video segment while it plays.

Various steps in the flow 100 may be changed in order, repeated, omitted, or the like without departing from the disclosed concepts. Various embodiments of the flow 100 can be included in a computer program product embodied in a non-transitory computer readable medium that includes code executable by one or more processors. Various embodiments of the flow 100, or portions thereof, can be included on a semiconductor chip and implemented in special purpose logic, programmable logic, and so on.

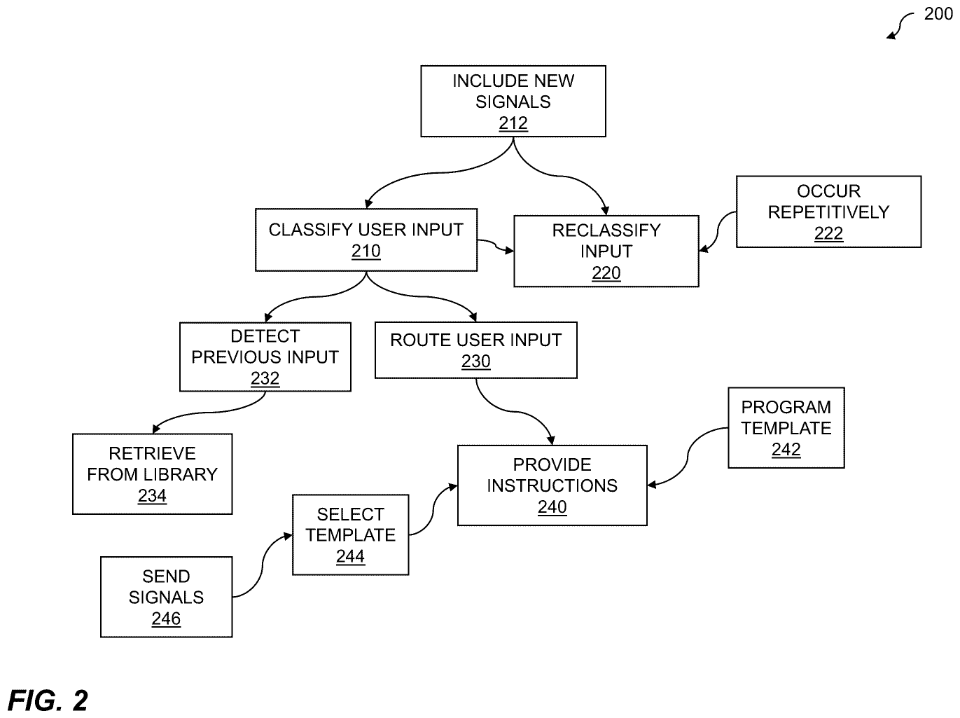

FIG. 2 is a flow diagram for providing instructions. The flow 200 includes classifying 210, by one or more classifiers, the user input, wherein the one or more classifiers operate in parallel, wherein classifying identifies a type of conversation, and wherein the classifying is based on the collecting. The one or more classifiers can include one or more lightweight LLMs. The one or more classifiers can include one or more semantic searches. The one or more classifiers can include any combination of lightweight LLMs, semantic searches, or another classifier. As mentioned above and throughout, there are many types of conversations that the users can have with the synthetic human, including inquiries, complaints, purchasing items, returning items, and so on. The type of conversation can include a greeting. People often respond to a cheerful greeting with one of their own, even when the initial greeting comes from a synthetic human host. For example, the synthetic human can begin with “Good morning!” The user can respond with “Good morning! How are you?” The one or more classifiers can classify this conversation and reply with “I'm doing very well, thank you. How may I help you?”, and so on. The type of conversation can include an inquiry. It is common for users to interact with websites to inquire about the status of a purchase order or shipment. The one or more classifiers can classify this type of conversation and route the inquiry to a module designed to collect the details quickly and assemble them into a response by the synthetic human. The type of conversation can include a chat. The chat may or may not be based on one or more products for sale on the website. Some users like to interact with synthetic humans for various reasons. Some are curious about how well the synthetic human performs. Others are looking to find the limits of the database generating the responses. Still others can simply be looking for someone to talk to. The type of conversation can include a sentiment. Users can contact a website to express satisfaction or dissatisfaction with a product. They may be angry or frustrated with a delivery schedule or shipment damage. They may be upset about interacting with a synthetic human as opposed to an actual human, and so on. The type of conversation can include a request for information. Depending on the type of website, the services, and the products being offered, user interactions can take many different forms with one or more agendas. The attitude of the user can vary as well, from happiness to anger, frustration to satisfaction. These factors can be classified by the one or more classifiers for routing to an appropriate module. The one or more classifiers can use the user signals along with the text of the user responses to classify the conversation.

In embodiments, the classifying includes reclassifying 220, by each of the one or more classifiers, the user input, wherein the reclassifying occurs repetitively 222 during the collecting. As the user continues to interact with the synthetic human, additional user input is gathered. The additional user input can shift the emphasis or completely alter the classification of the conversation. For example, a conversation that began as a simple inquiry can turn into a decision to purchase. A simple question about a product can turn into a troubleshooting conversation. A request for the status of a shipment can become a complaint about a late delivery. The one or more classifiers can continue to collect and analyze user input and reclassify 220 the conversation as it progresses and changes. In embodiments, the reclassifying can occur repetitively 222. In embodiments, the reclassifying occurs every 200 ms during the collecting. In embodiments, the reclassifying includes one or more new user signals 212. In further embodiments, one or more new signals include a new tone of the user. The one or more new signals can include additional gestures, facial expressions, the pace and rhythm of the user's words, vocabulary, and so on. As described previously, the one or more user signals can include demographic data of the user. Information about the age, sex, body parameters, and so on can be collected from the video information captured by the embedded interface. The one or more user signals can include a purchase history of the user. The one or more classifiers can include this information for use in responding to user inquiries about delivery dates, shipping costs, repeat purchases, and so on.

The flow 200 includes routing 230 the user input, by a controller, to one or more modules, wherein the routing is based on the classifying, and wherein the one or more modules provide instructions 240 to a final LLM. In embodiments, the one or more modules can arrange and prioritize user input based on the analysis of the one or more classifiers. The one or more modules can include an exploration module. A user can be at the early stages of a purchasing process. For example, the user may want to explore the pros and cons of a hybrid vehicle versus a fully electric car. The exploration module can help to construct a series of questions and collect user input to respond in the most helpful manner. The one or more modules can include a clarification module. Just as in a human conversation, the synthetic host can ask questions to better understand what the user is looking for. If a user wants to purchase a product but has not decided which to buy, clarifying questions can gain additional details that help the selection process. If the user is questioning a late shipment, more questions can help to pinpoint which shipment or which items in a shipment are the cause for concern, and so on. The one or more modules can include a closing module. A user may be ready to complete the purchase of a home, including collecting the proceeds from another home sale, paying fees, completing the mortgage process, and so on. In a usage example, the closing module can include details for handling escrows, mortgages, taxes, titles, insurance, realtor fees, and so on. The one or more modules can include sub-modules. In the usage example above, the selection of the specific sub-modules to be used can be varied based on an initial identification of the home being purchased, for example, or information from the lender. The one or more modules can include a finding help module. An LLM response in a library system can help a user to locate one or more books or articles on various topics, view a map to find the location of various titles, or understand how to access a virtual card catalog, for example. The finding help model can be configured to alert a human if the interaction is not judged to be helpful to the user. The one or more modules can include a troubleshooting module. The troubleshooting modules can be used when something goes wrong with the virtual assistant, a classifier suffers a hallucination, a hallucination level is exceeded, not enough product information is available to interact with the user, and so on. In embodiments, the one or more modules can include an advisory module. The advisory module can be used when the user is interested in obtaining advice. For example, the user may be interested in obtaining a wine pairing for a specific meal. The advisory module can be used to determine one or more pairings to suggest that the user consider purchasing. The advisory module can instruct the final LLM to take a more proactive tone with the user. Each module can be used to send instructions to the final LLM so that responses generated by the final LLM serve to provide the user the information they are requesting and to address the emotional content of the conversation. The modules can include acknowledgements of a user's anger or frustration, joy or sorrow, and can express words of sympathy or camaraderie in order to move a conversation forward and provide useful information.

The flow 200 includes detecting 232 a previous user input. As described above and throughout, the one or more classifiers can classify the type of interaction requested by the user. Recall also that previous responses to previous interactions can be stored in an accessible library. Also recall that the one or more classifiers can include a semantic search. One of the one or more classifiers can comprise a semantic search. The semantic search can search the library for previous interactions. The search can include not only information, but also user data, tone, emotion, and so on to best match the current interaction. Searching a library for previous answers can provide a faster way to generate an interaction with the user. Thus, in embodiments, the classifying includes detecting a previous user input. Further, in embodiments, the routing and the creating comprise retrieving, from a library 234, a response that was previously created. The retrieved interaction can be updated by a module to customize it for the current context and interaction.

In embodiments, the providing instructions 240 can be based on a template. In further embodiments, the template includes a markup language. A markup language can be used to specify the structure and formatting of a document. In can define how various elements of a document should be represented. A markup language can use tags to mark specific elements within the content of the document. In embodiments, the template used to provide instructions for the final LLM can have a defined structure based on a markup language. The markup language template can include tags for various user signals, such as the age or sex of the user, information about the most recent purchase made by the user, the tone of the user's language in the conversation, and so on. Further embodiments include programming 242 the template, wherein the programming is based on the markup language. The programming can include combining the collected user signals with the instructions template to produce a set of instructions specific to the conversation between a user and the synthetic human.

Embodiments include selecting 244 a template from a plurality of templates, wherein the selecting is based on the routing. The user data collected and analyzed by the one or more classifiers can be used to select a template that best matches the conversation between the user and synthetic human. For example, a conversation between the user and the synthetic human regarding the delivery time of a recent purchase can be used to select a clarification module. The clarification module can include one or more clarification templates that can be selected based on the tone of the user conversation, the purchased items being investigated, the shipping method used, and so on. Embodiments include sending 246 the one or more user signals to the template, wherein the sending is based on the markup language. Once a conversation template is selected, the user signals collected can be added to the template to produce a tailored set of instructions for the final LLM to use in generating a response to the user. For example, the user can ask for the delivery time and shipping method for a recent purchase of fountain pens. The user signals can include the details of the purchase order and the required information about shipping times, the carrier used, the expected delivery date, and so on. The tone of the user's voice can be analyzed to indicate that the user is calmly asking a question, rather than being agitated or angry about a late arrival of the items. Thus, the video produced and presented to the user, based on the final LLM response, can be delivered in a calm, business-like manner without any sort of apology or preamble to the review of the delivery details.

Various steps in the flow 200 may be changed in order, repeated, omitted, or the like without departing from the disclosed concepts. Various embodiments of the flow 200 can be included in a computer program product embodied in a non-transitory computer readable medium that includes code executable by one or more processors. Various embodiments of the flow 200, or portions thereof, can be included on a semiconductor chip and implemented in special purpose logic, programmable logic, and so on.

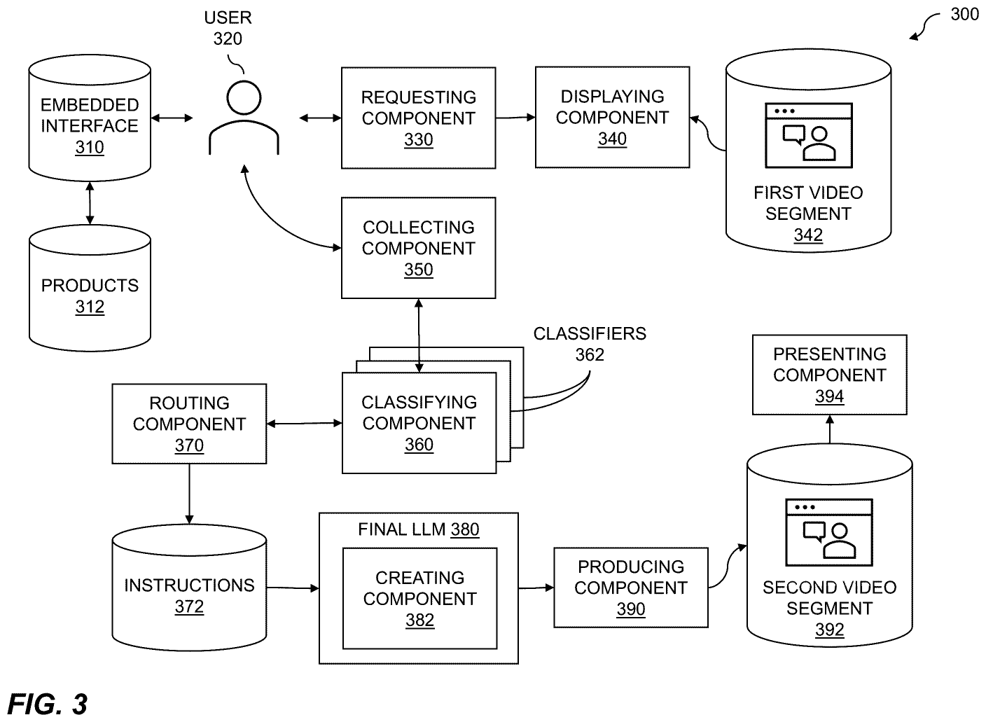

FIG. 3 is an infographic for an artificial intelligence virtual assistant using staged large language models. The infographic 300 includes accessing an embedded interface 310, wherein the embedded interface includes one or more products 312 for sale. In embodiments, the embedded interface can comprise a website. The website can be an ecommerce site for a single vendor or brand, a group of businesses, a social media platform, and so on. In embodiments, the website can be displayed on a portable device. The portable device can be an Over-the-Top (OTT) device such as a mobile phone, laptop computer, tablet, or pad. The accessing of the website can be accomplished using a browser running on the device. In embodiments, the embedded interface 310 comprises an app running on a mobile device. The app can use HTTP, TCP/IP, or DNS to communicate with the Internet, web servers, cloud-based platforms, and so on.

In embodiments, the one or more products for sale can be stored in a catalog. In some embodiments, the one or more products for sale can be identified with a stock keeping unit (SKU) number. The catalog can comprise a web page. The web page can host the catalog of products, or the catalog can be hosted by an associated cloud-based server, web server, and so on. The catalog can comprise products in a brick-and-mortar store. The brick-and-mortar store catalog can be stored in a local database server, an associated cloud-based server, a point-of-sale system, and so on. The catalog can include images, product specifications, vendor information, distributor information, product descriptions, stock keeping unit (SKU) numbers, pricing, availability, shipping information, dimensions, links to ecommerce sites associated with products, and/or other suitable information.

The infographic 300 includes a requesting component 330. The requesting component includes requesting, by a user, an interaction, wherein the interaction is based on a product for sale within the one or more products for sale. In embodiments, the user can request an interaction by clicking on an icon or button displayed in the embedded interface, clicking on a help button on a web page, asking for help in a text chat box, navigating to a help desk screen, pressing a phone button during a call, submitting an email to a help desk address, and so on. In other embodiments, the user can request an interaction by speaking into a microphone connected to the embedded interface. The microphone can be included on a computer, mobile device, and so on. The user can initiate an interaction from the main web page of a website, a help menu page, a web page presenting a specific product, a text or video chatbot embedded in the website, and so on.

The infographic 300 includes a displaying component 340. The displaying component 340 includes displaying, within the embedded interface 310, a first video segment 342, wherein the first video segment includes a synthetic human, wherein the first video segment initiates the interaction. In embodiments, the first video segment can display a synthetic human initiating a response to the user interaction request. In some embodiments, information about the user can be collected based on previous user interactions with the website, demographic data available from the video chat, social media platforms, search engine information, and so on. An AI machine learning model can analyze the user information to select a synthetic human host to interact with the user through the first video segment displayed in the embedded interface 310. For example, the synthetic host can say “How may I help you?” or “Good day! What can I do for you?” In cases where the user has asked for help from a specific product web page, the initial synthetic human interaction can be more specific. For example, “Hello. I see that you are looking at our universal cooking pot. What questions can I answer for you?”

The infographic 300 includes a collecting component 350. The collecting component 350 includes collecting, by the embedded interface 310, user input, wherein the collecting includes one or more user signals. In embodiments, the user input can comprise text. The user can respond to the synthetic human by typing a question or comment into a chat text box. The text box can be generated by the website or the embedded interface window. The user input can comprise audio input. In some embodiments, the audio input is included in a video chat. The user can speak to a video chat window; into a mobile phone, pad, or tablet; and so on. The collecting further comprises transforming the audio input into text, wherein the transforming is accomplished with a speech-to-text converter.

The infographic 300 includes a classifying component 360. The classifying component 360 includes classifying, by one or more classifiers 362, the user input, wherein the one or more classifiers operate in parallel, wherein the classifying identifies a type of conversation, and wherein the classifying is based on the collecting. In embodiments, the one or more classifiers can be trained with voice and text interactions between users, human sales associates, help desk staff members, product experts, and AI virtual assistants. The one or more classifiers can comprise a lightweight LLM. A lightweight LLM can comprise an “instant LLM” or a “low-parameter LLM.” The one or more classifiers can comprise a semantic search. The one or more classifiers can include any combination of lightweight LLMs, semantic searches, or other types of classifiers. Users can initiate an interaction with a human or synthetic host for many different reasons. Depending on the type of website, the services, and the products being offered, user interactions can take many different forms with one or more agendas. In addition, the attitude of the user can vary. Users can be calm or agitated, happy or angry, highly emotional and demonstrative, or at ease. All of these factors can be collected by the embedded interface and can be forwarded to the classifiers for analysis. The classifiers can include the user signals along with the text of the user responses to classify the conversation. The one or more classifiers can run in parallel on the user input. Running multiple processes in parallel ensures that the classification of the user input can occur quickly.

The infographic 300 includes a routing component 370. The routing component includes routing the user input, by a controller, to one or more modules, wherein the routing is based on the classifying, and wherein the one or more modules provide instructions 372 to a final LLM 380. In embodiments, one or more modules can be created to arrange and prioritize user input based on the analysis of the classifiers 362. The one or more modules can include an exploration module, a clarification module, a closing module, a finding help module, a troubleshooting module, an advisory module, and so on. Each module can be used to send instructions 372 to the final LLM 380 so that responses generated by the final LLM provide the user the information they are requesting and address the emotional content of the conversation. Good customer service requires that the website representative acknowledge and respond to the tone of the conversation, as well as provide informational details.

The infographic 300 includes a creating component 382. The creating component 382 includes creating, by the final LLM 380, a response to the interaction with the user 320, wherein the response is based on the instructions 372. In embodiments, the final LLM comprises a heavy LLM. The heavy LLM can comprise a “high parameter space LLM.” The final LLM can be trained on product and service data related to items sold by a website or a mobile application hosting the embedded interface. Additional training data can be provided by product vendor sites, product expert videos, marketing and advertising materials, sales staff input, and so on. Training data can be based on a knowledge base that is updated by a seller of the product for sale. Previous user interactions can also be included in the final LLM training data, so that the final LLM responses become increasingly tailored to the needs of the users. In embodiments, the conversation module selected by the one or more classifiers 362 can include all user input signals including the kind of information being sought and the general attitude of the user. The user information can be analyzed by the final LLM 380 to generate a response to the user that addresses both the emotional tone and the information-based aspects of the conversation between the user and synthetic human host. In embodiments, the final LLM response can be a text file that includes instructions for the video production step as well as the words to be spoken by the synthetic human. These instructions can include information on the verbal tone to be used by the synthetic human, facial expressions, body posture, speaking pace, and so on. For example, if a user is agitated or angry about a product, the synthetic human response can include instructions to respond in a calm, deliberate manner. The spoken script can include apologetic and empathetic language appropriate to the conversation. The synthetic human can offer alternate methods of communication, options to return or cancel an order, discounts on future purchases, and so on, based on the policies and preferences of the host website or vendor.

The infographic 300 includes a producing component 390. The producing component includes producing a second video segment 392, wherein the second video segment includes a performance by the synthetic human, wherein the performance includes the response that was created. In embodiments, the text of the response to the user generated by the final LLM 380 is used to create a set of video clips including the synthesized human performing the response. The text response to the user can be used to create an audio stream using the voice of the synthesized human used in the first response to the user. The audio stream can be broken down into smaller segments based on natural language processing (NLP) analysis. Each audio segment can be used to produce a video clip of the synthesized human performing the audio segment. Based on the content of the audio, the synthesized human can hold up and demonstrate a product, show the product at different angles, describe various ways of using the product, place the product on the synthetic head or body, and so on. In some embodiments, the audio segments can be sent to multiple processors to increase the rate at which video clips are produced and assembled into a second video segment 392.

The infographic 300 includes a presenting component 394. The presenting component 394 can include presenting, within the embedded interface 310, the second video segment 392 that was produced. In embodiments, the embedded interface can display the assembled video segment performed by the synthetic human in a web page window, video chat window, etc. The user can continue to interact with the synthetic human, generating additional input collected by the embedded interface. The collection of user input, analyzing of the conversation, creating a response, producing audio segments and related video clips, and presenting to the user can continue, so that the interaction between the user and the synthetic human appears as natural as two humans interacting within a video chat. In other embodiments, the voice of the synthetic human is heard in a phone call or text chat box. The conversation between the user and the synthetic human continues in the same way, with the LLMs analyzing input from the user and responding with text replies performed by the voice of the synthetic human.

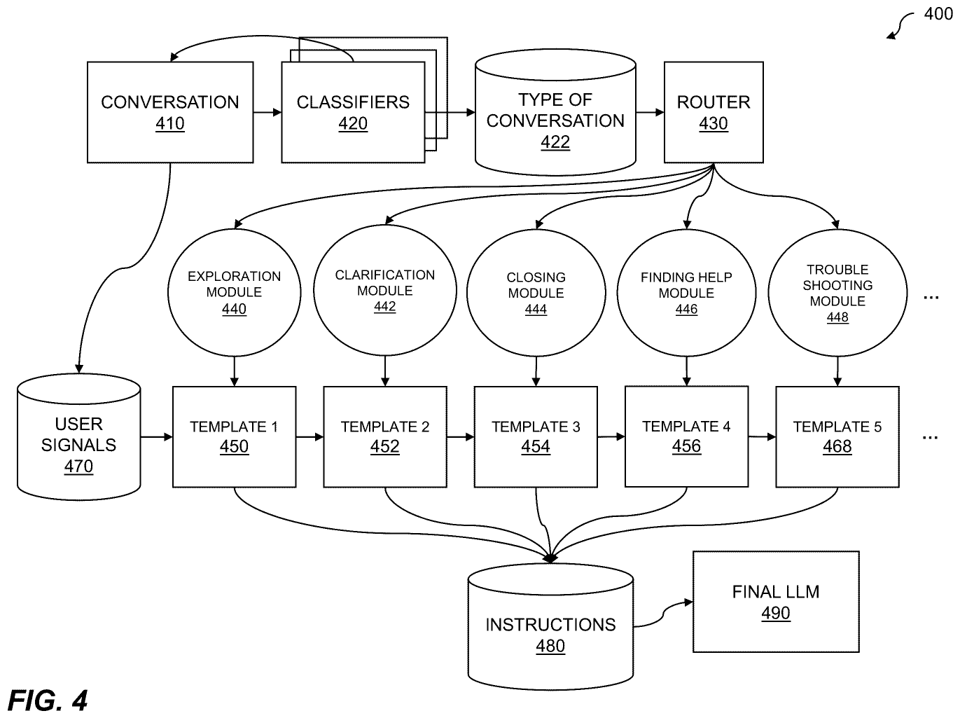

FIG. 4 is an infographic for routing to one or more modules. The infographic 400 includes classifying, by one or more classifiers 420, the user input, wherein the one or more classifiers operate in parallel, wherein the classifying identifies a type of conversation 422, and wherein the classifying is based on the collecting. In embodiments, the user input, including the conversation 410 being classified, can be collected by an embedded interface. As described throughout, the one or more classifiers can comprise one or more lightweight LLMs, one or more semantic searches, one or more other types of classifiers, or any combination thereof. The classifiers can be trained with voice and text interactions between users, human sales associates, help desk staff members, product experts, and AI virtual assistants.

In embodiments, the classifiers 420 can analyze and classify the user input, including the conversation 410 between the user and the synthetic human, to identify the type of conversation 422. The user input can be analyzed to extract one or more user signals 470. As mentioned above and throughout, the user signals can include emotions and gestures of the user, purchase information, shipping information, demographics, and so on. Depending on the type of website, the services, and the products being offered, user interactions can take many different forms with one or more agendas. The attitude of the user can vary. Users can be calm or agitated, happy or angry, highly emotional and demonstrative, or at ease. These factors can be collected by the embedded interface and forwarded to the one or more classifiers for analysis. The classifiers 420 can include the user signals along with the text of the user responses to classify the conversation. The classification information can be included in decisions regarding how to manage the user conversation in later steps.

The infographic 400 includes routing 430 the user input, by a controller, to one or more modules, wherein the routing is based on the classifying, and wherein the one or more modules provide instructions to a final LLM. The one or more modules include an exploration module 440. The one or more modules include a clarification module 442. The one or more modules include a closing module 444. The one or more modules include a finding help module 446. The one or more modules include a troubleshooting module 448. Other modules, such as an advisory module, can be included. Each module can be used to create instructions 480 which can be used by the final LLM 490 so that responses generated by the final LLM provide the user the information they are requesting and address the emotional content of the conversation. The modules can include acknowledgements of a user's anger or frustration, joy or sorrow, and can express words of sympathy or camaraderie along with information about the product or service under discussion in order to move a conversation forward and provide useful direction for the customer.

In embodiments, the providing instructions is based on one or more templates. The example 400 includes template 1 450 for exploration module 440, template 2 452 for clarification module 442, template 3 454 for closing module 444, template 4 456 for finding help module 446, and template 5 468 for troubleshooting module 448. Additional templates can be used for other modules based on user input collected by the embedded interface. In embodiments, the template can include a markup language. The template used to provide instructions for the final LLM can have a defined structure based on a markup language. The markup language template can include tags for various user signals, such as the age or sex of the user, information about the most recent purchase made by the user, the tone of the user's language in the conversation, and so on. The providing instructions can further comprise programming the template, wherein the programming is based on the markup language. The programming can include combining the collected user signals with the instructions template to produce a set of instructions specific to the conversation between a user and the synthetic human.

In embodiments, the providing instructions can further comprise selecting a template from a plurality of templates, wherein the selecting is based on the routing 430. The user data collected and analyzed by the one or more classifiers 420 can be used to select a template that best matches the conversation between the user and synthetic human. The providing instructions can further comprise sending one or more user signals 470 to the template, wherein the sending is based on the markup language. Once a conversation template is selected, the user signals collected by the embedded interface can be added to the template to produce a tailored set of instructions 480 for the final LLM 490 to use in generating a response to the user.

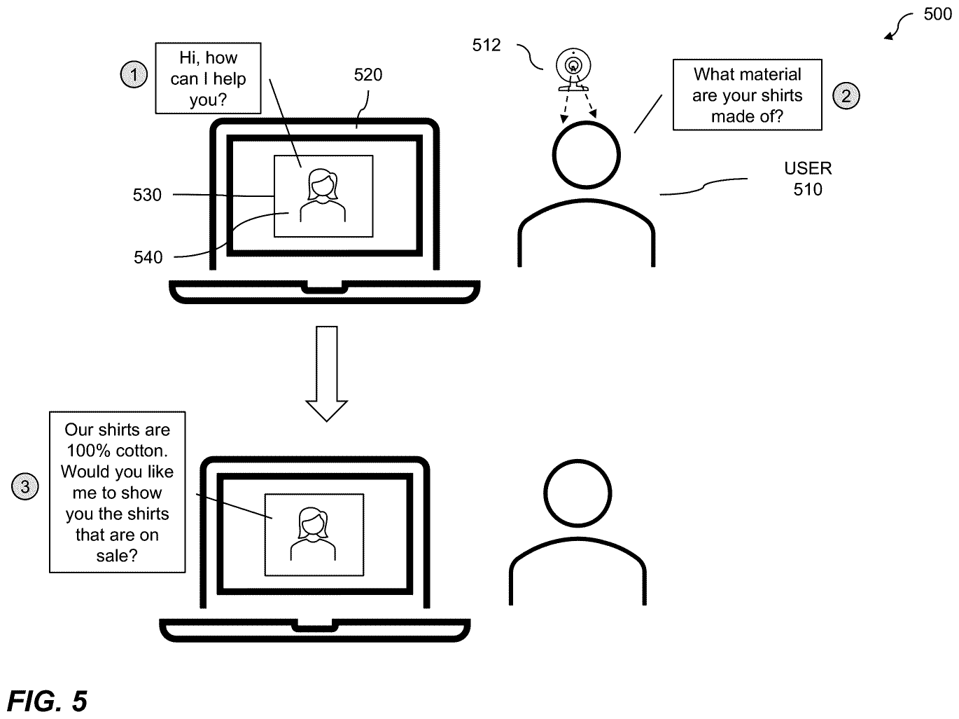

FIG. 5 is an example of an interaction with an artificial intelligence virtual assistant. The example 500 is shown in three stages. In stage 1, the example 500 includes requesting, by a user 510, an interaction, wherein the interaction is based on a product for sale within the one or more products for sale. The user accesses a website with products for sale via an embedded interface 520. The embedded interface recognizes a user request for an interaction, based on the user clicking on a help button, asking for more information in a video or audio chat, asking a question in a text box, etc. In some embodiments, information about the user is collected based on previous user interactions with the website, demographic data available from the video chat, social media platforms, search engine information, and so on. An AI machine learning model uses the user information to select a synthetic human 540 to interact with the user 510 through a first video segment 530 displayed in the embedded interface 520. In the example 500, the synthetic human is shown saying, “Hi, how can I help you?”

In stage 2 of the example 500, the user 510 responds to the synthetic human in the first video segment with a question, “What materials are your shirts made of?” The user can respond with voice. The user can respond with voice and video via a camera or webcam 512 that can be coupled to the embedded interface. The audio and video can be captured with a computer, cell phone, mobile device, and so on. The webcam 512 can capture more data about the user than can be helpful in formulating an appropriate response. For example, the user's face may indicate anger which can be sent as a signal to the final LLM to create an appropriate response. Video data can also be used to determine whether the user is paying attention or is distracted. The camera and audio can provide two-way communication between the user and the synthetic human. The example 500 includes collecting, by the embedded interface 520, the user audio input. The user input, for example, the question about shirt material, is collected by an AI machine learning model that includes a large language model (LLM) that uses natural language processing (NLP). In some embodiments, the AI machine learning model analyzes the user input and generates a response based on information articles contained in a SQUAD dataset. The SQUAD dataset is formatted to contain hundreds of questions and answers generated from the information articles on products and services offered for sale on the website. The AI machine learning model can analyze the question asked by the user and select the best response based on the product information stored in the dataset.

The example 500 includes creating, by an LLM, a response to the interaction with the user. In stage 3 of the example 500, the one or more classifiers analyze the conversation to determine the type of conversation occurring. The one or more classifiers select a template best suited to the conversation, fill in user signals such as cotton shirts, and forward the template to the final LLM. The final LLM uses the instruction template to generate a text response to the user question. The response is, “Our shirts are 100% cotton. Would you like me to show you the shirts that are on sale?” The entire text response is generated using the same voice of the synthetic human used in the first video segment (Stage 1) to create an audio stream. In embodiments, the audio stream can be edited to include pauses, speaking errors, accents, idioms, and so on to make the audio sound as natural as possible. The audio stream can be separated into segments based on the natural auditory cadence of the stream. Each segment is used to generate a video clip of the synthetic human host performing the audio segment. The audio segments are sent to one or more separate processors so that each video clip can be generated quickly and reassembled in order to be presented to the user. In embodiments, the video clips can be produced and presented to the user as additional clips are being generated. The user 510 can respond to the second video clip with additional questions, comments, and so on. For example, the user in the example 500 can say, “Yes, please do.” The AI machine learning model can then collect the response from the user and display the shirts on sale from the website. Additional videos of the synthetic human can be generated, discussing additional details of the shirts, informing the user about matching clothing items such as pants, jackets, accessories, and so on.

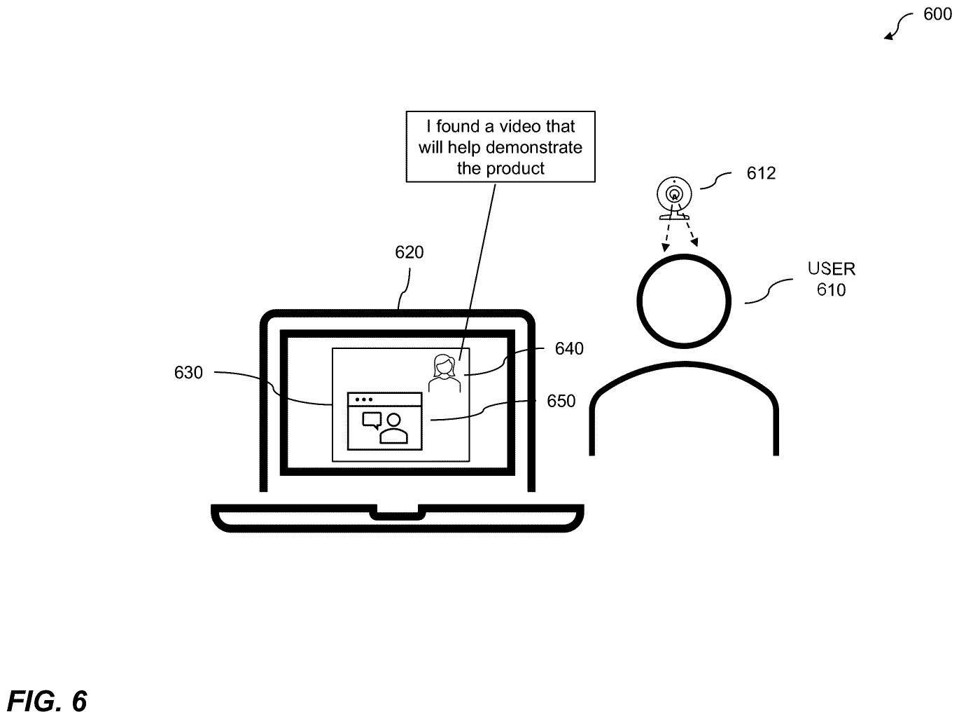

FIG. 6 is an example of an artificial intelligence virtual assistant showing a short-form video. The example 600 includes displaying, within the embedded interface 620, a first video segment 630, wherein the first video segment includes a synthetic human host 640. The first video segment 630 can include a short-form video 650 presented by the synthetic human host 640. As described above and throughout, the embedded interface 620 includes an artificial intelligence virtual assistant, wherein the artificial intelligence virtual assistant comprises a synthetic human host 640, wherein the audio input from the user relates to one or more products for sale. In embodiments, the user input can be captured by a natural language processing (NLP) engine, analyzed by one or more LLMs, and a final response to the user input can be generated. In embodiments, the final response can include one or more short-form videos that relate to a product or service in which the user is interested. Product demonstrations, livestreams, product expert reviews, social media influencer videos, and so on can be accessed by the LLM and can be included in the final response to the user. In embodiments, the LLM final response includes pointers, URLs, etc. to reference and access the short-form videos.

The example 600 includes producing a final video segment 630, wherein the producing includes animating the artificial intelligence virtual assistant. In embodiments, the final video segment includes the short-form video 650 included by the LLM in the final response to the user. The LLM final response includes text to introduce and explain the short-form video that is included. In the example 600, the synthetic human host 640 is saying, “I found a video that will help demonstrate the product.” The short-form video 650 can be seen along with the synthetic human host as the video plays the product demonstration for the user. In embodiments, as the short-form video plays, additional user input can be captured and analyzed by the one or more classifiers. The user can provide the additional input via voice. The user can provide the additional input via voice and video via a camera or webcam 612 that can be coupled to the embedded interface. The webcam 612 can capture more data about the user that can be helpful in formulating an appropriate response. Audio and video can be captured with a computer, cell phone, mobile device, and so on. For example, the user's face may indicate anger which can be sent as a signal to the final LLM to create an appropriate response. The camera and audio can provide two-way communication between the user and the synthetic human. The one or more classifiers can determine the type of conversation between the user and synthetic host and select a module best suited to respond to the user comment or question. The module can include a template that can be programmed and combined with user signals to generate instructions for a final LLM. The final LLM can use the instructions to generate additional dialogue for the synthetic human host. For example, the user 610 may ask about pricing or delivery times for the product as the demonstration short-form video plays. The embedded interface 620 can capture the user questions, forward them to the NLP, convert them to text, analyze the text with the one or more classifiers, generate an answer, convert the text of the final LLM response to video, and insert the video of the synthetic human host into the video segment 630 so that the host can respond to the user question as the demonstration video continues to play. In embodiments, an ecommerce environment can be included in the video segment so that the user can purchase products as the video continues to play.

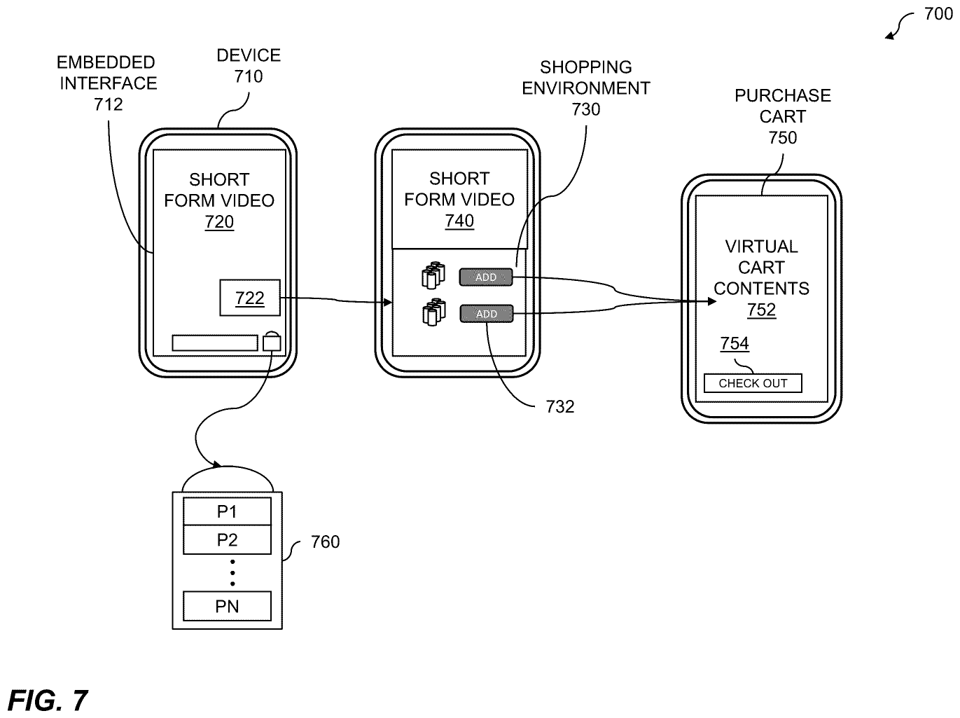

FIG. 7 is an example of an ecommerce purchase. As described above and throughout, a user can interact with an artificial intelligence virtual assistant regarding items for sale. In the example 700, the interaction can be enabled by an embedded interface 712. The embedded interface can be included on a device 710. The device 710 can be a smart TV which can be directly attached to the Internet; a television connected to the Internet via a cable box, TV stick, or game console; an Over-the-Top (OTT) device such as a mobile phone, laptop computer, tablet, pad, or desktop computer; etc. The interaction can include one or more answers generated by the final LLM which can be produced into one or more video segments displayed. During the interaction, the first video segment, the second video segment, and other video segments can be streamed to the user. In embodiments, the streaming of any of the video segments comprises a short-form video. The short-form video 720 can include a separate window that demonstrates a product for sale while the artificial intelligence artificial assistant, which can comprise one or more streamed video segments, is shown in the embedded interface. In embodiments, the short-form video 720 can be viewed in real time or replayed at a later time. In embodiments, the accessing the short-form video 720 on the device 710 via the embedded interface 712 can be accomplished using a browser, mobile application, or another application running on the device. The device can comprise a computer, tablet, smart phone, or another mobile device.

The example 700 can include generating and revealing a product card 722 on the device 710. In embodiments, the product card represents at least one product available for purchase while the short-form video plays. Embodiments can include inserting a representation of the first object into the on-screen product card. A product card is a graphical element such as an icon, thumbnail picture, thumbnail video, symbol, or other suitable element that is displayed in front of the short-form video. The product card can be selectable via a user interface action such as a press, swipe, gesture, mouse click, verbal utterance, or other suitable user action. The product card 722 can be inserted when the short-form video is visible. When the product card is invoked, an in-frame shopping environment 730 can be rendered over a portion of the short-form video while the short-form video continues to play. This rendering enables an ecommerce purchase 732 by a user while preserving a continuous short-form video playback session. In other words, the user is not redirected to another site or portal that causes the short-form video playback to stop. Thus, viewers are able to initiate and complete a purchase completely inside of the short-form video playback user interface, without being directed away from the currently playing short-form video. Allowing the short-form video event to play during the purchase can enable improved audience engagement, which can lead to additional sales and revenue, one of the key benefits of disclosed embodiments. In some embodiments, the additional on-screen display that is rendered upon selection or invocation of a product card conforms to an Interactive Advertising Bureau (IAB) format. A variety of sizes are included in IAB formats, such as for a smartphone banner, mobile phone interstitial, and the like.

The example 700 can include rendering an in-frame shopping environment 730. The rendering can enable a purchase of the at least one product for sale by the viewer, wherein the ecommerce purchase is accomplished within the short-form video window 740. The short-form video window can be enabled by the embedded interface 712. In embodiments, the short-form video window can include a real time short-form video, a prerecorded short-form video segment, a livestream, a livestream replay, one or more video segments comprising an answer from an artificial intelligence virtual assistant, and so on. The short-form window can include any combination of the aforementioned options. The enabling can include revealing a virtual purchase cart 750 that supports checkout 754 of virtual cart contents 752, including specifying various payment methods, and application of coupons and/or promotional codes. In some embodiments, the payment methods can include fiat currencies such as United States dollar (USD), as well as virtual currencies, including cryptocurrencies such as Bitcoin. In some embodiments, more than one object (product) can be highlighted and enabled for ecommerce purchase. In embodiments, when multiple items 760 are purchased via product cards during the short-form video, the purchases are cached until termination of the short-form video, at which point the orders are processed as a batch. The termination of the short-form video can include the user stopping playback, the user exiting the video window, the short-form video ending, or a prerecorded short-form video ending. The batch order process can enable a more efficient use of computer resources, such as network bandwidth, by processing the orders together as a batch instead of processing each order individually.

Embodiments include enabling an ecommerce purchase of the one or more products for sale. The enabling can be within the short-form video. In other embodiments, the ecommerce purchase includes a representation of the one or more products for sale in an on-screen product card. In some embodiments, the enabling the ecommerce purchase includes a virtual purchase cart. In further embodiments, the virtual purchase cart covers a portion of the second video segment.

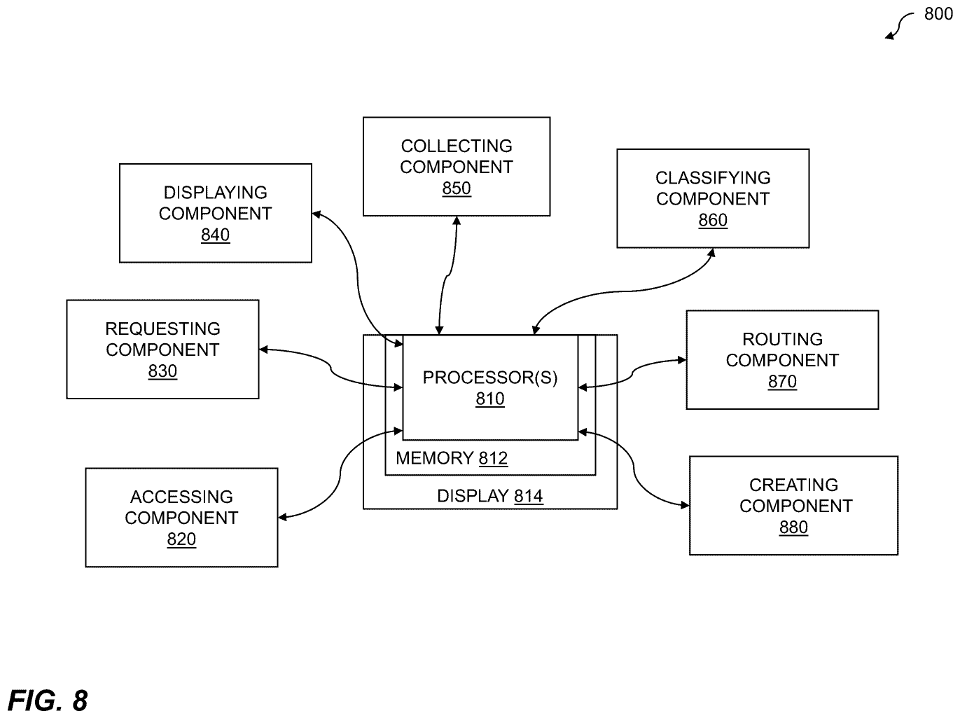

FIG. 8 is a system diagram for an artificial intelligence virtual assistant using staged large language models. The system 800 can include one or more processors 810 coupled to a memory 812 that stores instructions. The system 800 can include a display 814 coupled to the one or more processors 810 for displaying data, video streams, videos, video metadata, synthesized images, synthesized image sequences, synthesized videos search results, sorted search results, search parameters, metadata, web pages, intermediate steps, instructions, and so on. In embodiments, one or more processors 810 are coupled to the memory 812 where the one or more processors, when executing the instructions which are stored, are configured to: access an embedded interface, wherein the embedded interface includes one or more products for sale; request, by a user, an interaction, wherein the interaction is based on a product for sale within the one or more products for sale; display, within the embedded interface, a first video segment, wherein the first video segment includes a synthetic human, wherein the first video segment initiates the interaction; collect, by the embedded interface, user input, wherein the collecting includes one or more user signals; classify, by one or more classifiers, the user input, wherein the one or more classifiers operate in parallel, wherein the classifying identifies a type of conversation, and wherein the classifying is based on the collecting; route the user input, by a controller, to one or more modules, wherein the routing is based on the classifying, and wherein the one or more modules provide instructions to a final large language model (LLM); and create, by the final LLM, a response to the interaction with the user, wherein the response is based on the instructions.

The system 800 includes an accessing component 820. The accessing component 820 includes functions and instructions for accessing an embedded interface, wherein the embedded interface includes one or more products for sale. In embodiments, the embedded interface can comprise a website. The website can be an ecommerce site for a single vendor or brand, a group of businesses, a social media platform, and so on. In embodiments, the website can be displayed on a portable device. The portable device can be an Over-the-Top (OTT) device such as a mobile phone, laptop computer, tablet, or pad. The accessing of the website can be accomplished using a browser running on the device. In embodiments, the embedded interface comprises an app running on a mobile device. The app can use HTTP, TCP/IP, or DNS to communicate with the Internet, web servers, cloud-based platforms, and so on.

The system 800 includes a requesting component 830. The requesting component 830 includes functions and instructions for requesting, by a user, an interaction, wherein the interaction is based on a product for sale within the one or more products for sale. In embodiments, the user can request an interaction by clicking on an icon or button displayed in the embedded interface, clicking on a help button on a web page, asking for help in a text chat box, navigating to a help desk screen, pressing a phone button during a call, submitting an email to a help desk address, and so on. The user can initiate an interaction from the main web page of a website, a help menu page, a web page presenting a specific product, a text or video chatbot embedded in the website, and so on.

The system 800 includes a displaying component 840. The displaying component 840 includes functions and instructions for displaying, within the embedded interface, a first video segment, wherein the first video segment includes a synthetic human, wherein the first video segment initiates the interaction. In embodiments, the first video segment can display a synthetic human initiating a response to the user interaction request. The displaying component 840 includes functions and instructions for displaying, within the embedded interface, a second video segment, wherein the second video segment includes a synthetic human, wherein the second video segment continues the interaction between the user and synthetic human. As the conversation continues, subsequent videos can be displayed based on collected user input, LLM analyses, and answers generated by the final LLM.

The system 800 includes a collecting component 850. The collecting component 850 includes functions and instructions for collecting, by the embedded interface, user input, wherein the collecting includes one or more user signals. In embodiments, the user input can comprise text. The user can respond to the synthetic human by typing a question or comment into a chat text box. The text box can be generated by the website or the embedded interface window. The user input can comprise audio input. The user input can comprise video. In some embodiments, the audio input is included in a video chat. The user can speak to a video chat window; into a mobile phone, pad, tablet, and so on. The collecting further comprises transforming the audio input into text, wherein the transforming is accomplished with speech-to-text converter. Regardless of the method selected by the user, the user input can be transformed into text that can be fed into the final LLM to create a response.

In embodiments, user signals captured by the collecting component 850 can include information from the website or mobile device hosting the embedded interface. The user signals can include demographic data of the user. The user signals can include a purchase history of the user. The user signals can include user location, website and social media search information gathered from search engines, and so on, to be forwarded to one or more classifiers along with the text of user verbal responses. User signals can also include gestures and a verbal tone of the user. A tone of the user can comprise a sentiment. In some embodiments, a Mel spectrogram audio analysis of the user responses can be used to distinguish spoken words, recognize specific voices, or separate environmental noise from voices. In some embodiments, the audio analysis can be used to distinguish emotional content in the voice of the speaker. The Mel spectrogram audio analysis can be used to distinguish individual words and phonemes that make up words in user input.

The system 800 includes a classifying component 860. The classifying component 860 includes functions and instructions for classifying, by one or more classifiers, the user input, wherein the one or more classifiers operate in parallel, wherein the classifying identifies a type of conversation, and wherein the classifying is based on the collecting. In embodiments, the one or more classifiers can be trained with voice and text interactions between users, human sales associates, help desk staff members, product experts, and AI virtual assistants. The one or more classifiers can comprise a lightweight LLM, a semantic search, another classifier, or any combination of the same. In embodiments, the one or more classifiers can analyze and classify the user input to identify the type of conversation between the synthetic human and the user.

The system 800 includes a routing component 870. The routing component 870 includes functions and instructions for routing the user input, by a controller, to one or more modules, wherein the routing is based on the classifying, and wherein the one or more modules provide instructions to a final LLM. In embodiments, one or more modules can be created to arrange and prioritize user input based on the analysis of the one or more classifiers. The one or more modules can include an exploration module. The one or more modules can include a clarification module. The one or more modules can include a closing module. The one or more modules can include a finding help module. The one or more modules can include a troubleshooting module, and so on. Each module can be used to send instructions to the final LLM so that responses generated by the final LLM serve to provide the user the information they are requesting and address the emotional content of the conversation.

The system 800 includes a creating component 880. The creating component 880 includes functions and instructions for creating, by the final LLM, a response to the interaction with the user, wherein the response is based on the instructions. In embodiments, the final LLM comprises a heavy LLM. The final LLM can be trained on product and service data related to items sold by website or mobile application hosting the embedded interface. Additional training data can be provided by product vendor sites, product expert videos, marketing and advertising materials, sales staff input, a product knowledgebase, and so on. Previous user interactions can also be included in the final LLM training data, so that the final LLM responses become more tailored to the needs of the users. In embodiments, the conversation module selected by the one or more classifiers can include all user input signals including the kind of information being sought and the general attitude of the user. The user information can be analyzed by the final LLM to generate a response to the user that addresses both the emotional tone and the information-based aspects of the conversation between the user and synthetic human host. In embodiments, the final LLM response can be a text file that includes instructions for the video production step, as well as the words to be spoken by the synthetic human.

The system 800 can include a computer program product embodied in a non-transitory computer readable medium for video processing, the computer program product comprising code which causes one or more processors to perform operations of: accessing an embedded interface, wherein the embedded interface includes one or more products for sale; requesting, by a user, an interaction, wherein the interaction is based on a product for sale within the one or more products for sale; displaying, within the embedded interface, a first video segment, wherein the first video segment includes a synthetic human, wherein the first video segment initiates the interaction; collecting, by the embedded interface, user input, wherein the collecting includes one or more user signals; classifying, by one or more classifiers, the user input, wherein the one or more classifiers operate in parallel, wherein the classifying identifies a type of conversation, and wherein the classifying is based on the collecting; routing the user input, by a controller, to one or more modules, wherein the routing is based on the classifying, and wherein the one or more modules provide instructions to a final large language model (LLM); and creating, by the final LLM, a response to the interaction with the user, wherein the response is based on the instructions.

Each of the above methods may be executed on one or more processors on one or more computer systems. Embodiments may include various forms of distributed computing, client/server computing, and cloud-based computing. Further, it will be understood that the depicted steps or boxes contained in this disclosure's flow charts are solely illustrative and explanatory. The steps may be modified, omitted, repeated, or re-ordered without departing from the scope of this disclosure. Further, each step may contain one or more sub-steps. While the foregoing drawings and description set forth functional aspects of the disclosed systems, no particular implementation or arrangement of software and/or hardware should be inferred from these descriptions unless explicitly stated or otherwise clear from the context. All such arrangements of software and/or hardware are intended to fall within the scope of this disclosure.

The block diagram and flow diagram illustrations depict methods, apparatus, systems, and computer program products. The elements and combinations of elements in the block diagrams and flow diagrams show functions, steps, or groups of steps of the methods, apparatus, systems, computer program products and/or computer-implemented methods. Any and all such functions-generally referred to herein as a “circuit,” “module,” or “system”—may be implemented by computer program instructions, by special-purpose hardware-based computer systems, by combinations of special purpose hardware and computer instructions, by combinations of general-purpose hardware and computer instructions, and so on.

A programmable apparatus which executes any of the above-mentioned computer program products or computer-implemented methods may include one or more microprocessors, microcontrollers, embedded microcontrollers, programmable digital signal processors, programmable devices, programmable gate arrays, programmable array logic, memory devices, application specific integrated circuits, or the like. Each may be suitably employed or configured to process computer program instructions, execute computer logic, store computer data, and so on.

It will be understood that a computer may include a computer program product from a computer-readable storage medium and that this medium may be internal or external, removable and replaceable, or fixed. In addition, a computer may include a Basic Input/Output System (BIOS), firmware, an operating system, a database, or the like that may include, interface with, or support the software and hardware described herein.

Embodiments of the present invention are limited to neither conventional computer applications nor the programmable apparatus that run them. To illustrate: the embodiments of the presently claimed invention could include an optical computer, quantum computer, analog computer, or the like. A computer program may be loaded onto a computer to produce a particular machine that may perform any and all of the depicted functions. This particular machine provides a means for carrying out any and all of the depicted functions.

Any combination of one or more computer readable media may be utilized including but not limited to: a non-transitory computer readable medium for storage; an electronic, magnetic, optical, electromagnetic, infrared, or semiconductor computer readable storage medium or any suitable combination of the foregoing; a portable computer diskette; a hard disk; a random access memory (RAM); a read-only memory (ROM); an erasable programmable read-only memory (EPROM, Flash, MRAM, FeRAM, or phase change memory); an optical fiber; a portable compact disc; an optical storage device; a magnetic storage device; or any suitable combination of the foregoing. In the context of this document, a computer readable storage medium may be any tangible medium that can contain or store a program for use by or in connection with an instruction execution system, apparatus, or device.

It will be appreciated that computer program instructions may include computer executable code. A variety of languages for expressing computer program instructions may include without limitation C, C++, Java, JavaScript™, ActionScript™, assembly language, Lisp, Perl, Tcl, Python, Ruby, hardware description languages, database programming languages, functional programming languages, imperative programming languages, and so on. In embodiments, computer program instructions may be stored, compiled, or interpreted to run on a computer, a programmable data processing apparatus, a heterogeneous combination of processors or processor architectures, and so on. Without limitation, embodiments of the present invention may take the form of web-based computer software, which includes client/server software, software-as-a-service, peer-to-peer software, or the like.

In embodiments, a computer may enable execution of computer program instructions including multiple programs or threads. The multiple programs or threads may be processed approximately simultaneously to enhance utilization of the processor and to facilitate substantially simultaneous functions. By way of implementation, any and all methods, program codes, program instructions, and the like described herein may be implemented in one or more threads which may in turn spawn other threads, which may themselves have priorities associated with them. In some embodiments, a computer may process these threads based on priority or other order.

Unless explicitly stated or otherwise clear from the context, the verbs “execute” and “process” may be used interchangeably to indicate execute, process, interpret, compile, assemble, link, load, or a combination of the foregoing. Therefore, embodiments that execute or process computer program instructions, computer-executable code, or the like may act upon the instructions or code in any and all of the ways described. Further, the method steps shown are intended to include any suitable method of causing one or more parties or entities to perform the steps. The parties performing a step, or portion of a step, need not be located within a particular geographic location or country boundary. For instance, if an entity located within the United States causes a method step, or portion thereof, to be performed outside of the United States, then the method is considered to be performed in the United States by virtue of the causal entity.

While the invention has been disclosed in connection with preferred embodiments shown and described in detail, various modifications and improvements thereon will become apparent to those skilled in the art. Accordingly, the foregoing examples should not limit the spirit and scope of the present invention; rather it should be understood in the broadest sense allowable by law.

What is claimed is:

1. A computer-implemented method for video processing comprising:
accessing an embedded interface, wherein the embedded interface includes one or more products for sale;
requesting, by a user, an interaction, wherein the interaction is based on a product for sale within the one or more products for sale;
displaying, within the embedded interface, a first video segment, wherein the first video segment includes a synthetic human, wherein the first video segment initiates the interaction;
collecting, by the embedded interface, user input, wherein the collecting includes one or more user signals;
classifying, by one or more classifiers, the user input, wherein the one or more classifiers operate in parallel, wherein the classifying identifies a type of conversation, and wherein the classifying is based on the collecting;
routing the user input, by a controller, to one or more modules, wherein the routing is based on the classifying, and wherein the one or more modules provide instructions to a final large language model (LLM); and
creating, by the final LLM, a response to the interaction with the user, wherein the response is based on the instructions.

2. The method of claim 1 wherein the classifying includes reclassifying, by each of the one or more classifiers, the user input, wherein the reclassifying occurs repetitively during the collecting.

3. The method of claim 2 wherein the reclassifying occurs every 200 ms during the collecting.

4. The method of claim 2 wherein the reclassifying includes one or more new user signals.

5. The method of claim 4 wherein the one or more new user signals includes a new tone of the user.

6. The method of claim 1 further comprising storing, in a library, the response to the interaction.

7. The method of claim 1 wherein the classifying includes detecting a previous user input.

8. The method of claim 7 wherein the routing and the creating comprise retrieving, from a library, a response that was previously created.

9. The method of claim 1 wherein the providing instructions is based on a template.

10. The method of claim 9 wherein the template includes a markup language.

11. The method of claim 10 further comprising programming the template, wherein the programming is based on the markup language.

12. The method of claim 10 further comprising selecting a template from a plurality of templates, wherein the selecting is based on the routing.

13. The method of claim 12 further comprising sending the one or more user signals to the template, wherein the sending is based on the markup language.

14. The method of claim 1 further comprising producing a second video segment, wherein the second video segment includes a performance by the synthetic human, wherein the performance includes the response that was created.

15. The method of claim 14 further comprising presenting, within the embedded interface, the second video segment that was produced.

16. The method of claim 1 wherein the one or more user signals include a tone of the user.

17. The method of claim 1 wherein the one or more user signals include demographic data of the user.

18. The method of claim 1 wherein the one or more user signals include a purchase history of the user.

19. The method of claim 1 wherein the one or more user signals include a video or picture of the user.

20. The method of claim 1 wherein the one or more user signals include a probability of introducing, by the one or more classifiers, a hallucination.

21. The method of claim 20 further comprising setting a hallucination tolerance level.

22. The method of claim 1 wherein the classifying includes a knowledge tree, wherein the knowledge tree identifies information needed, by the final LLM, for the creating.

23. A computer program product embodied in a non-transitory computer readable medium for video processing, the computer program product comprising code which causes one or more processors to perform operations of:
accessing an embedded interface, wherein the embedded interface includes one or more products for sale;
requesting, by a user, an interaction, wherein the interaction is based on a product for sale within the one or more products for sale;
displaying, within the embedded interface, a first video segment, wherein the first video segment includes a synthetic human, wherein the first video segment initiates the interaction;
collecting, by the embedded interface, user input, wherein the collecting includes one or more user signals;
classifying, by one or more classifiers, the user input, wherein the one or more classifiers operate in parallel, wherein the classifying identifies a type of conversation, and wherein the classifying is based on the collecting;
routing the user input, by a controller, to one or more modules, wherein the routing is based on the classifying, and wherein the one or more modules provide instructions to a final large language model (LLM); and
creating, by the final LLM, a response to the interaction with the user, wherein the response is based on the instructions.

24. A computer system for video processing comprising:
a memory which stores instructions;
one or more processors coupled to the memory wherein the one or more processors, when executing the instructions which are stored, are configured to:
access an embedded interface, wherein the embedded interface includes one or more products for sale;
request, by a user, an interaction, wherein the interaction is based on a product for sale within the one or more products for sale;
display, within the embedded interface, a first video segment, wherein the first video segment includes a synthetic human, wherein the first video segment initiates the interaction;
collect, by the embedded interface, user input, wherein the collecting includes one or more user signals;
classify, by one or more classifiers, the user input, wherein the one or more classifiers operate in parallel, wherein the classifying identifies a type of conversation, and wherein the classifying is based on the collecting;
route the user input, by a controller, to one or more modules, wherein the routing is based on the classifying, and wherein the one or more modules provide instructions to a final large language model (LLM); and
create, by the final LLM, a response to the interaction with the user, wherein the response is based on the instructions.
